(19) United States
(12) Patent Application Publication
(10) Pub. No.: US 2023/0324275 A1
(43) Pub. Date: Oct. 12, 2023

(54) A SIMPLE IN-LINE DIGITAL HOLOGRAPHY SYSTEM FOR MEASURING 3D CELL SHAPE

(71) Applicants: The Regents of the University of California, Oakland, CA (US); The University of Massachusetts Dartmouth, North Dartmouth, MA (US)

(72) Inventors: ROBERT OHGAMI, San Francisco, CA (US); HANGJIAN LING, NORTH DARTMOUTH, MA (US); KAUSHIK SRIDHAR, San Francisco, CA (US)

(21) Appl. No.: 18/040,730

(22) PCT Filed: Aug. 6, 2021
(86) PCT No.: PCT/US21/44912

§ 371 Date: Feb. 6, 2023

Related U.S. Application Data
(60) Provisional application No. 63/062,878, filed on Aug. 7, 2020.

(51) Int. Cl. G01N 15/14; G03H 1/04; G02B 21/00; G02B 21/36; G03H 1/00

(52) U.S. Cl. CPC G01N 15/1434; G03H 1/0443; G02B 21/0004; G02B 21/361; G03H 1/0005; G03H 1/0465; G01N 2015/0073

(57) ABSTRACT

The present disclosure presents systems, apparatuses, and methods of holographic imaging. In this regard, a method comprises transmitting light and illuminating a semi-transparent sample object; and forming, at a hologram plane, an interference pattern of a real image of the sample object from a scattered object beam and an unscattered reference beam from the transmitted light. To do so, the scattered object beam and the unscattered reference beam are in-line with one another, and a distance between the hologram plane to the sample object is set at a distance that substantially weakens a virtual image of the sample object formed from the scattered object beam and the unscattered reference beam. Accordingly, the method further comprises recording the interference pattern of a hologram formed from the scattered object beam and the unscattered reference beam at a detector; and reconstructing a 3D optical field of the hologram without phase retrieval.

### CROSS-REFERENCE TO RELATED APPLICATION

This application claims priority to co-pending U.S. provisional application entitled, “Simple In-Line Digital Holography System for Measuring 3D Cell Shape,” having Ser. No. 63/062,878, filed Aug. 7, 2020, which is entirely incorporated herein by reference.

### TECHNICAL FIELD

The present disclosure is generally related to digital holography microscopy.

### BACKGROUND

The measurement of the three-dimensional (3D) shape of blood cells, such as red blood cells (RBCs), white blood cells (WBCs), and platelets (PLTs), have been routinely used in clinical setting to guide diagnoses. The measured 3D shape provides important biophysical parameters including two-dimensional (2D) morphology, thickness, size, and volume, which can vary and be diagnostic in some pathological conditions, such as cancer, metabolic disorders, and infections. Various types of technologies including blood cell counter, phase contrast microscopy, and digital holography have been implemented to obtain such 3D information. Among them, digital holographic microscopy (DHM) is a unique method due to its advantages of low cost, ease of use, real-time feedback, label-free approach, and wide field of view. DHM is based on recording an interference (i.e., a hologram) between reference and object waves at a detector (e.g., camera), where a coherent or partially coherent light is used as the light source and the 3D optical field (including both intensity and phase) is numerically reconstructed from the recorded hologram. For blood cells that are mostly or semi-transparent, the thickness of the sample can be calculated based on the reconstructed phases.

Depending on whether the reference and object waves are in-line or not, there are two types of optical setups in DHM: the in-line and off-axis setups. The advantage of an off-axis setup is that the reconstructed 3D field is free of twin image noise and the reconstructed phase truly represents the cell thickness. But, the off-axis setup has smaller interference finger spacing on the holograms which add higher requirements to the digital sensor. In addition, the off-axis setup requires a separated reference beam which complicates the optical setup.

The in-line setup is another widely used configuration to record the holograms of cells. Advantageously, the in-line setup has larger fringe patterns and is easier to implement in experiments. The disadvantage is that the reconstructed images include twin image noise which can cause errors in phase and cell thickness. Several types of solutions have been developed to address the twin image problem. For example, one can immerse the object into a media with a comparable refractive index to minimize the phase shift. Jericho et al. applied this method to estimate the thickness of various types of cells and showed good concordance. See M. H. Jericho, H. J. Kreuzer, M. Kanka, and R. Riesenberg, “Quantitative Phase and Refractive Index Measurements with Point-Source Digital In-Line Holographic Microscopy,” Appl. Opt. (2012).

When the objects have a strong phase shift, one can remove virtual images by applying phase-shifting digital holography and an iterative phase retrieval method. In phase-shifting digital holography, multiple holograms are recorded where the phase of a separated reference beam is shifted. This method requires a separated reference beam, similar to the off-axis DHM, which complicates the optical setup.

### SUMMARY

Embodiments of the present disclosure provide holographic imaging systems, apparatuses, and methods. Briefly described, one embodiment of the method comprises transmitting light and illuminating a semi-transparent sample object; forming, at a hologram plane, an interference pattern of a real image of the sample object from a scattered object beam and an unscattered reference beam from the transmitted light, wherein the scattered object beam and the unscattered reference beam are in-line with one another, wherein a distance between the hologram plane to the sample object is set at a distance that substantially weakens a virtual image of the sample object formed from the scattered object beam and the unscattered reference beam; recording the interference pattern of a hologram formed from the scattered object beam and the unscattered reference beam at a detector; and reconstructing a 3D optical field of the hologram of the sample object to the hologram plane without phase retrieval.

The present disclosure also presents holographic imaging apparatuses and systems. One embodiment of such an holographic imaging device comprises a light source configured to transmit light and illuminate a semi-transparent sample object; wherein, at a hologram plane, an interference pattern of a real image of the sample object is formed from a scattered object beam and an unscattered reference beam from the transmitted light, wherein the scattered object beam and the unscattered reference beam are in-line with one another, wherein the sample object is set at a distance from the hologram plane that substantially weakens a virtual image of the sample object from a scattered object beam and an unscattered reference beam; a detector configured to record an interference pattern of a hologram of the sample object formed from a scattered object beam and an unscattered reference beam from the transmitted light; and a computer processor configured to: reconstruct a 3D optical field of the hologram of the sample object to the hologram plane without phase retrieval; calculate a phase distributions of the hologram from the reconstructed 3D optical field; and calculate a thickness or volume of the sample object based on the phase distribution of the hologram.

In one or more aspects for such systems and/or methods, the sample object comprises a red blood cell mounted on a glass slide; a source of the light is a Helium-Neon (HeNe) laser with a wavelength of 633 nm; the detector comprises a Complementary Metal Oxide Semiconductor (CMOS) camera; the light source is coherent; the distance between the sample object and the hologram plane reduces a measurement error of cell volume due to the virtual image to be less than 6%; the distance between the sample object and the hologram plane reduces an error of reconstructed phase due to the virtual image to be less than 10%; and/or the distance between the sample object and the hologram plane is at least 50 μm.

In one or more aspects for such systems and/or methods, an exemplary system/method can further perform operations comprising calculating a phase distribution of the hologram from the reconstructed 3D optical field; calculating a thickness or volume of the sample object based on the phase distribution of the hologram; spatially filtering and collimating the light before illuminating the sample object; magnifying the hologram and transmitting the magnified hologram to the detector for recording of the hologram; and/or implementing an autofocusing algorithm that identifies sharp features in the reconstructed optical field based on intensity variations.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a schematic of an exemplary digital in-line holography set up in accordance with various embodiments of the present disclosure.

FIG. 2 shows an algorithmic workflow for the calculation of a cell 3D shape from a digital holographic microscopy platform and its corresponding RGB (Red Green Blue) image in accordance with the present disclosure.

FIGS. 3A-3D shows original and reconstructed phase distributions of an object during a numerical test of phase reconstruction in an in-line hologram without removing the virtual image in accordance with various embodiments of the present disclosure.

FIG. 3E shows phase distributions across the center of the original object and the reconstructed image during the numerical test of phase reconstruction in an in-line hologram without removing the virtual image in accordance with various embodiments of the present disclosure.

FIG. 3F shows the error of the reconstructed phase during the numerical test of phase reconstruction in an in-line hologram without removing the virtual image in accordance with various embodiments of the present disclosure.

FIGS. 4A-4C show (A) the reconstructed phase distribution at different locations along an optical path; (B) the gradient of the phase distribution corresponding to FIG. 4A; and (C) the focal parameter obtained based on the gradient of the phase distribution or image sharpness in order to determine the focal plane of a sample/cell in accordance with various embodiments of the present disclosure.

FIGS. 5A-5B shows images of (A) holograms with cells located at varying distances along the hologram plane and (B) the corresponding phase reconstructions in accordance with various embodiments of the present disclosure.

FIGS. 6A-6C show a data analysis of volumetric information from hologram reconstruction using an exemplary digital in-line holography technique and mean corpuscular volume (MCV) values from a hematology analyzer (blood counter) in accordance with the present disclosure.

FIGS. 7A-7B show a comparison of the phase distribution obtained from (A) reconstructing a single hologram without phase retrieval in accordance with various embodiments of the present disclosure; and (B) reconstructing with phase retrieval based on two holograms.

FIG. 8 depicts a schematic block diagram of a computing device that can be used to implement various embodiments of the present disclosure.

### DETAILED DESCRIPTION

The present disclosure describes various embodiments of systems, apparatuses, and methods for an imaging system utilizing in-line digital holographic microscopy (DHM) without separation of a reference beam to recover a 3D shape and a volume of cells mounted on glass slides, thereby capturing morphologic and volumetric data. Accordingly, the present disclosure presents an in-line DHM due to a simple optical setup. One aim for such a simple imaging system is the evaluation of a 3D shape and a volume of cells mounted on glass slides. Due to the in-line setup, a reconstructed phase is affected by virtual image noise. By increasing the distance between a cell and a hologram plane, the present disclosure shows that the virtual image signal becomes weaker and the measurement error is reduced to less than 10%. In comparison, the iterative phase retrieval method may be used to remove the virtual images. In the iterative phase retrieval method, the wave is propagated back and forth among multiple planes with constraints applied on the object or hologram planes. This method is attractive since it can be implemented in the simplest Gabor setup, where no additional optical elements are inserted to split the light beam. However, results show that the iterative phase retrieval method does not improve the measurement quality due to the persistence of background noise on the raw holograms caused by debris and scratches on the slides affecting the light path.

In general, the measurement of the three-dimensional (3D) shape of blood cells is important for clinical diagnosis and patient management. The measured 3D shape provides important biophysical parameters including two-dimensional (2D) morphology, thickness, size, and volume, which can be altered in a variety of pathological conditions such as hyperglycemia & hypernatremia. Digital holography microscopy (DHM) has long been used to obtain such 3D information. However, previous optical setups usually involve a separated reference beam and are thus not very easy to implement. In contrast, the present disclosure uses a simple in-line Gabor setup without separation of a reference beam to measure the 3D shape and volume of cells mounted on glass slides. Inherent to the in-line holograms, the reconstructed phase is affected by the virtual image. Thus, embodiments of the present disclosure use a single hologram without phase retrieval, increasing the distance between the cell and hologram plane to reduce the measurement error of cell volume to less than 6% in some instances. Therefore, the in-line Gabor setup of an exemplary in-line digital holographic microscopy system/method can be a useful and simple tool to obtain volumetric and morphologic cellular information.

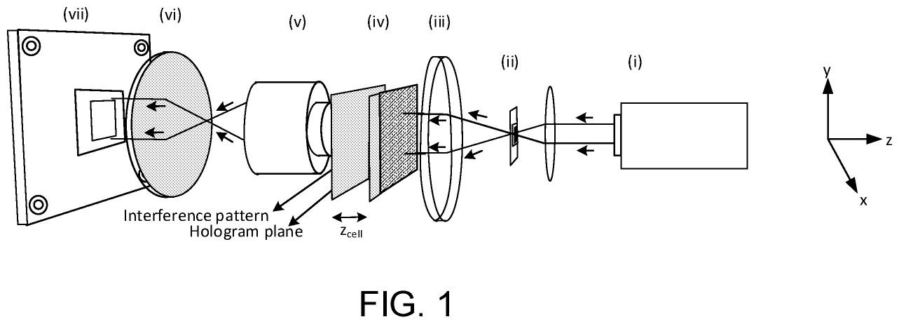

Referring now to FIG. 1, the figure presents a schematic of a digital in-line holography setup in accordance with various embodiments of the present disclosure. The optical setup includes (i) Laser light source; (ii) Spatial filter; (iii) Collimator lens; (iv) Tissue sample on microscopy glass slide (e.g., of dimensions 25×75 mm); (v) Microscopy objective; (vi) Tube lens; and (vii) Complementary Metal Oxide Semiconductor (CMOS) camera (e.g., of area 2048×2048 pixels, pixel size=5.5 μm). The location of the hologram plane is defined at z=0.

In an exemplary and non-limiting implementation, a Helium-Neon (HeNe) laser with a wavelength of 633 nm (Newport Corporation) is used to illuminate the sample volume. The laser beam is spatially filtered and collimated before illuminating the sample. The scattered light by object(s) (object wave) and the undisturbed light (reference wave) form interference patterns, i.e., the holograms. In the exemplary implementation, the hologram is magnified by a 40× microscope objective (Olympus, NA=0.65, infinity corrected), transmitted by a 1× tube lens (focal length 180 mm), and then recorded on a detector (e.g. CMOS camera (FLIR, Grasshopper, GS3-U3-41C6M-C)).

The present disclosure uses a Cartesian coordinate system (x, y, z), where x and y denote the two directions perpendicular to the optical axis, and z represents the direction of the light beam. The hologram plane is defined at z=0. z_{cell} is used to denote the distance between the hologram plane and object plane where the cells are mounted on the glass slides. The intensity distributions of the hologram are described by the following equation as:

I(x,y;z=0)=|R+O|²=|R|²+|O|²+RO*+R*O, (1)

where R and O represent the complex amplitudes of reference and object waves at plane z=0 respectively, and superscript * denotes conjugate. The complex optical field (including both amplitude and phase) at the object plane z=z_{cell} can be reconstructed from hologram l as:

U(x,y;z=z_{cell})=l⊗h(x,y,z=z_{cell}), (2)

where ⊗ represents convolution and h(x, y, z) is a diffraction kernel. We choose the Rayleigh-Sommerfeld diffraction formula, h=zliλ(x²+y²+z²)^{0.5} exp{ik(x²+y²+z²)^{0.5}}. Then, the phase distribution on the object plane can be calculated as:

Δθ′(x,y)=a tan(lm{U}/Re{U})(mod 2π). (3)

Inherent to the in-line setup, the reconstructed optical field is affected by virtual image noise, where the reconstructed phase could have negative values due to the effect of the virtual image. In reality, the phase shift caused by the sample should always be positive given that the sample has a larger refractive index than that of the surrounding medium. To avoid false negative phase values in the reconstruction, the phase obtained from Equation (3) can be corrected by:

Δθ(x,y)=Δθ′−min(Δθ′). (4)

While Equation (4) does not entirely remove the effect of a virtual image, it allows us to estimate the average phase value of the object when the magnitude of z_{cell} is properly selected. Typically, a phase unwrapping algorithm needs to be performed to remove the ˜2π discontinuities in the spatial distribution of the phase. In the current setup, considering the maximal phase shift caused by the RBCs is less than 1π, no phase unwrapping is required.

The physical thickness of cell is given by:

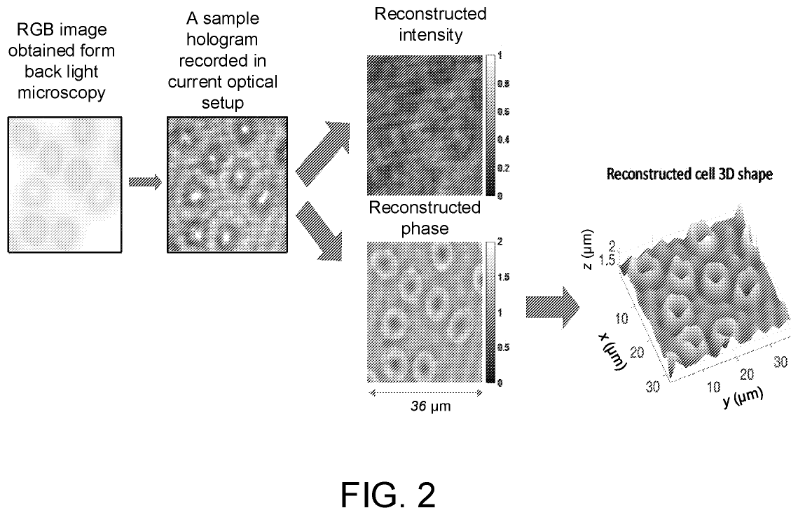

d(x,y)=λ(Δθ/2π)/(n_{cell}−n_{med}), (5)

where λ is the wavelength, and n_{cell} and n_{med} are the refractive index of the cell and the surrounding medium of cell. To make a blood smear slide, a drop of blood was placed on a slide and extended with a cover slip at a 45° angle. After drying at room temperature for 15-20 minutes, the cells on the slide were fixed with methanol and stained with Wright-Giemsa; a glass coverslip was then applied using mounting media. The refractive indices of RBCs and the mounting media are n_{cell}=1.4 and n_{med}=1.33 according to the existing literature. The algorithmic workflow for the calculation of the cell 3D shape from DHM platform and its corresponding RGB (Red Green Blue) image (described above) is illustrated in FIG. 2, in which the hologram is recorded at z_{cell}=15 μm.

Note, in trial experiments, the raw holograms are used for the reconstruction and analysis of cell thickness. The raw hologram contains fringe patterns generated by debris and scratches on the slide where the cells are mounted. If the cells are free to move, e.g., immersed in a container, an image containing only background noise can be calculated by recording a series of images and then taking the mean of these images. Subsequently, a hologram without background noise can be obtained by subtracting or dividing this background image. In the current study, however, the cells are fixed on the slide and are not free to move. As a result, the signals (containing only background noise) are unable to be separated from the holograms generated by background noise and cells.

Because of the background noise, iterative phase retrieval methods fail to remove the virtual image and do not improve the quality of the reconstructed phase image. Under this situation, one needs to select a relatively large distance between a sample and the hologram plane (z_{cell}) such that the virtual image signal is weaker. Interestingly, without removing the virtual image, the error of reconstructed phase is less than 10% when the z_{cell} is sufficiently large.

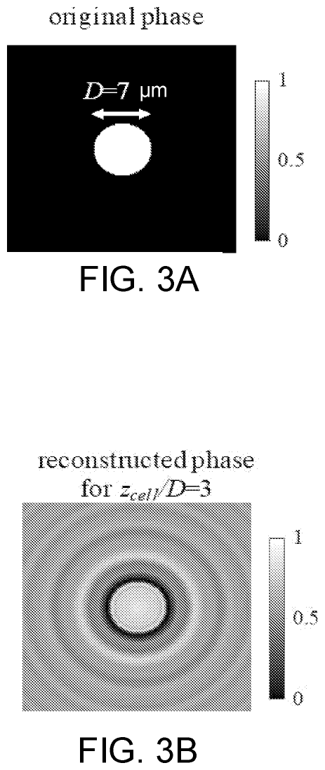

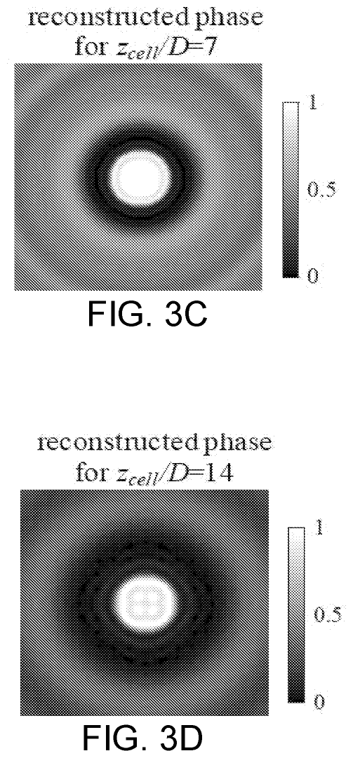

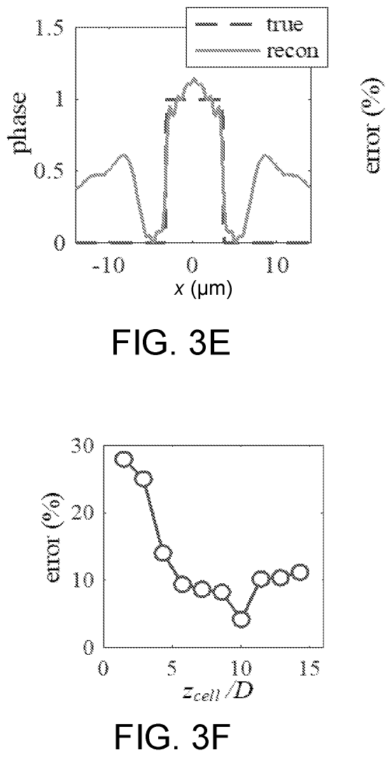

Next, the phase reconstruction from a single hologram is numerically tested and the distance at which the effect of a virtual image can be ignored is studied. During a test simulation, the object is a 2D disk having a transmission function t(x, y) as:

$$t ( x , y ) = \{ \begin{matrix}exp ( 1 i ) , & {( x - {x}_{c} )}^{2} + {( y - {y}_{c} )}^{2} \leq {D}^{2} / 4 \\ 1 , & {( x - {x}_{c} )}^{2} + {( y - {y}_{c} )}^{2} > {D}^{2} / 4\end{matrix} , \qquad ( 6 )$$

where (x_{c}, y_{c}) denotes the centroid of the object on the hologram and D denotes the diameter of the object. Thus, a uniform phase shift (here, one wavelength of light) is applied to a region within the object, where the intensity of the light remains the same after passing through the object. The reason for applying only one wavelength phase shift is to simulate weak phase-shift objects (i.e., those having similar refractive index with the surrounding medium). However, this method may not be applicable for strong phase-shift objects. The original phase distribution for an object with D=7 μm is shown in FIG. 3A.

Then, following the procedures as previously described, the synthetic hologram l(x, y) can be generated based on diffraction theory:

l(x,y)=|t(x,y)⊗h(x,y,z=z_{cell})|². (7)

Accordingly, the synthetic hologram may then be reconstructed to the location of the original object (i.e., object plane) by Equation (2) and the reconstructed phase distribution obtained by Equation (3).

To study hologram reconstruction further, holograms for objects at various distances to the hologram plane ranging from z_{cell}=D to z_{cell}=15D are simulated, where D denotes the cell diameter. In turn, each hologram is reconstructed to the object plane to calculate the phase distributions. Correspondingly, FIGS. 3B-3D show the reconstructed phases for objects located at z_{cell}=3 D, 7 D, and 14 D. Clearly, the reconstructed images demonstrate the original object shape in the center of the image, but with the addition of background noise due to the effects of the virtual image. The magnitude of the reconstructed phase for the object is also very similar to the original one, as shown in FIG. 3E. To quantify the error of the reconstructed phase, the average phase value within the reconstructed object is calculated. As shown in FIG. 3F, the error of the average phase value is reduced from 30% to about 10% with increasing z_{cell} from 1 D to 10 D. However, increasing z_{cell} beyond that will introduce an additional error due to the cutoff of the fringe pattern by the finite sensor size. The relevant parameters in the simulation are: λ=633 nm, pixel size 0.14 μm (equivalent to the using of a camera with pixel size of 5.5 um and a 40× objective), image size 600 pixels, and cell diameter D=7 μm.

Before calculating the phase and thickness of the sample, the parameter well, i.e., the distance between the sample and the hologram plane, must be known. However, this parameter is not a previously known variable in the present experiment. Thus, to determine z_{cell}, the hologram to various distances z is reconstructed and the image sharpness of the reconstructed phase is compared. In the trial experiment, the sample is a weak phase-shift object; thus, the image gradient caused by phase wrapping is not a significant factor for our analysis.

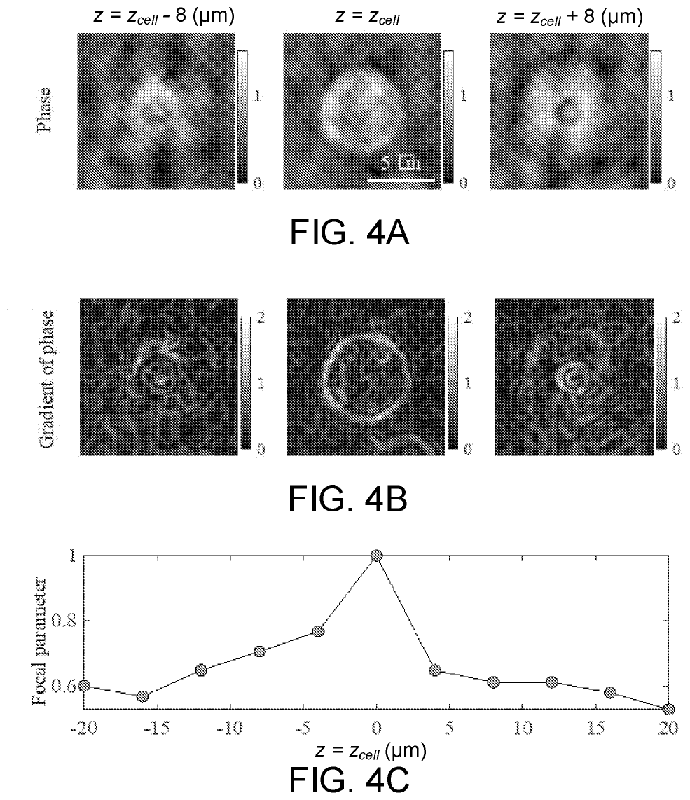

FIG. 4A shows the reconstructed phase distribution at different z locations near z_{cell}; FIG. 4B shows the gradient of the phase distribution corresponding to FIG. 4A; and FIG. 4C shows the focal parameter obtained based on the image sharpness (i.e., the gradient of the phase image near the cell edges). As shown in the figures, the phase distribution has the sharpest edges near the cell boundaries when z=z_{cell}. The focal plane was attempted to be determined based on the plane of minimal amplitude. However, the minimal amplitude does not have a sharp peak compared to the phase, likely due to background noise.

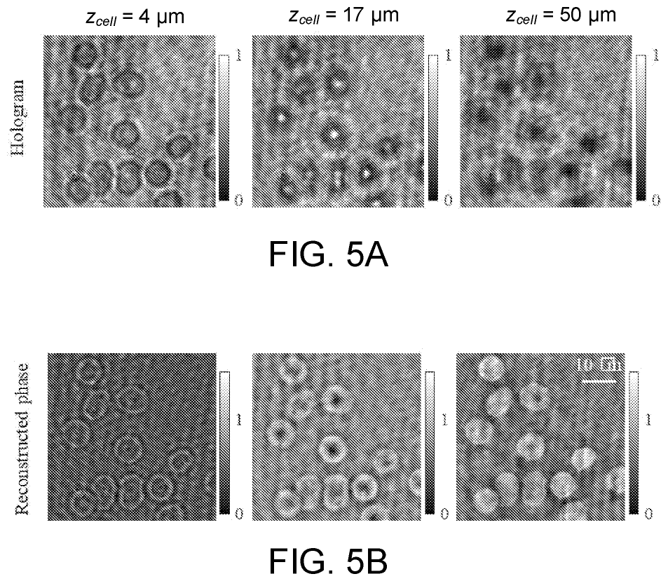

As shown in the simulation, due to the effect of virtual image noise, the reconstructed phase may not represent the original thickness of the sample. The error of the reconstructed phase reduces with increasing z_{cell}. In the trial experiment, the slide is moved along the optical path, and several holograms of the same cells are recorded at various well. Each hologram is reconstructed to the object plane and the resulting phase distribution is compared. As shown in FIGS. 5A-5B, as z_{cell} increases, the reconstructed phase shows higher sharpness due to the weaker signal of the virtual image. Some cells may have lower phase values in the cell center possibly due to the sample variability in RBC shapes, and the noise due to background fringes and virtual images. Holograms recorded at z_{cell}=50 μm are utilized for the analysis of cell thickness and volume.

Accordingly, the cell volume V can be estimated from the reconstructed phase at the focal plane z=z_{cell} since the volume data provides clinically relevant information. Currently, a manual image segmentation is used to detect the regions that belong to the cells. The area of each segmented region can be calculated and denoted as S, and the thickness of the selected region can be evaluated using Equation (4). In the following analysis, the average thickness of the selected cell is calculated by accounting for variations over the cell surface and is denoted as d_{cell}. Finally, the cell volume can be estimated as V=Sd_{cell}.

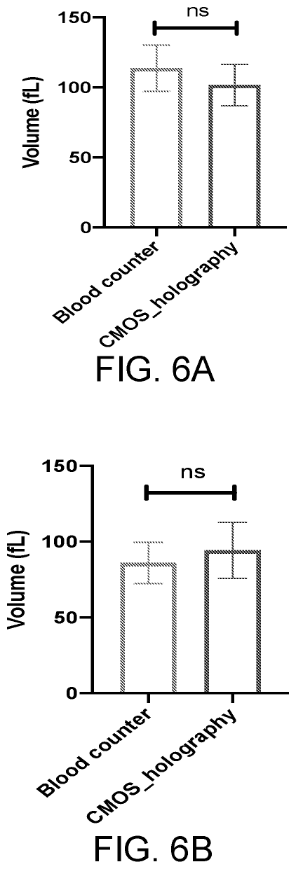

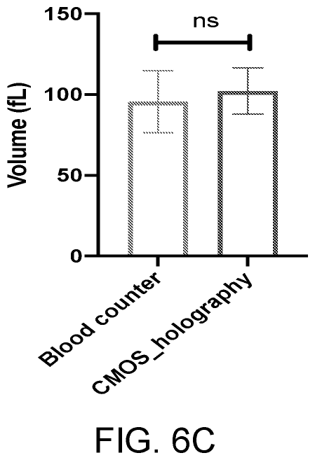

Using this procedure, a total of 97 cells from three different peripheral blood smear slides was analyzed and the resulting volumetric information was compared to the mean corpuscular volume (MCV) data obtained from automated hematology analyzers (DxH 900, Beckman Coulter). It is noted that hematology analyzers are routinely used in the clinical setting and considered the gold standard for generating complete blood count (CBC) laboratory results. A one-sample t-test at a confidence interval of 99% was performed to compare the DHM experimental data to the MCV values from the hematology analyzer. It was found that there was no statistically significant difference (ns) observed between the CMOS derived volumetric data and the hematology analyzer (blood (cell) counter), as shown in FIGS. 6A-6C. In FIG. 6A, Sample 1 shows a standard error (SE) of 5.23% and a discrepancy of 5.96 compared to MCV values; in FIG. 6B, Sample 2 shows a SE of 9.72% and a discrepancy of 8.35 compared to MCV values; and in FIG. 6C, Sample 5 shows a SE of 6.50% and a discrepancy of 6.50 compared to MCV.

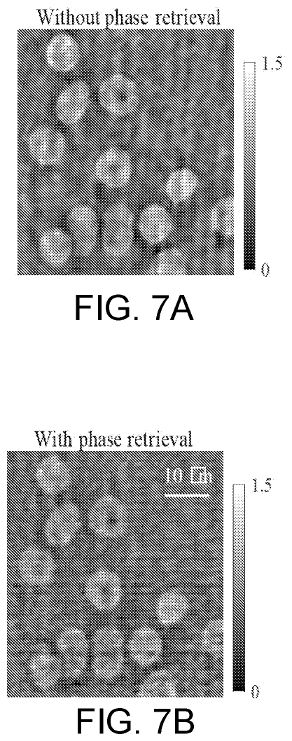

The following discussion assesses the performance of reconstructed phase distributions based on two holograms with phase retrieval versus one hologram without phase retrieval. In general, the phase retrieval method is based on the estimation of the missing phase information on the hologram plane and has been successfully implemented in previous studies to remove the virtual image and improve the accuracy of phase reconstruction. In most of these studies, the holograms are free of background noise. In the present study, we tested whether the phase retrieval method can be implemented to the raw holograms containing background noise. The two holograms shown in FIG. 5A that were recorded for the same sample located at z_{cell}=17 μm and z_{cell}=50 μm were used. The Gerchberg-Saxton iterative phase retrieval algorithm/method was applied to estimate the phase distribution on both hologram planes. This method involves the propagation of light field back and forth between the two hologram planes. After obtaining the complex amplitudes at both hologram planes, the hologram planes are reconstructed to the object plane to obtain phase distribution of the cells. In the present study, the result is compared with the one obtained from direct reconstruction of a single hologram. As shown in FIGS. 7A-7B, the phase retrieval method based on two holograms (FIG. 7B) does not improve the quality of reconstructed phase distributions of a single hologram without phase retrieval (FIG. 7A). In various embodiments, the reconstruction operations can be performed by a computer processor.

In accordance with the present disclosure, a simple in-line DHM setup is presented and used to extract 3D information from peripheral blood smear slides in the absence of phase retrieval methods. The resulting volumetric information was compared with the currently accepted gold standard technique, a hematology analyzer, and no significant difference was observed. An optimized distance between the sample and hologram plane of 50 μm (z_{cell}) was used to reduce the virtual image noise artifacts without the use of a separated reference beam. It is possible to further reduce the virtual noise in various embodiments of the imaging system by implementing an autofocusing algorithm that identifies the sharpest features in the reconstructed images based on the intensity variations. Given the simplicity of the setup, some embodiments of an exemplary imaging system may integrate convolutional neural networks (CNN) pipelines along with data reconstruction to identify features in various disease pathologies. In various embodiments, the foregoing operations can be performed by a computer processor.

The foregoing technologies and described systems/methods can be integrated and include within a variety of industries and applications involving a cell blood counter that calculates volume of cells and works on glass slides of peripheral blood as a sample, a digital microscope that can capture the depth/thickness of biofilms on tissues, a digital microscope that can calculate volumes of organoids, the non-destructive testing of surfaces to identify/characterize surface defects and materials, 3D monitoring of cells and their reaction to drugs for various disease conditions, used in combination with next generation sequencing methodologies to draw correlations between genotypic and phenotypic features, integrated with deep learning pipelines to perform histopathological analysis of cells, etc. Advantages of such technologies over current technologies or products include that cellular volumetric data can be calculated not only for live cells, but also for fixed cells, less intensive data storage required here as raw data extracted from this method is very small (˜4 Mb) whereas traditional microscopic techniques for 3D analysis (e.g., Confocal) generate raw data >1 Gb, faster workflow is available as multiple focal depth information is obtained simultaneously without the need to shift the light source or sample, real-time imaging and analysis is possible, etc. In various embodiments, the calculation operations can be performed by a computer processor.

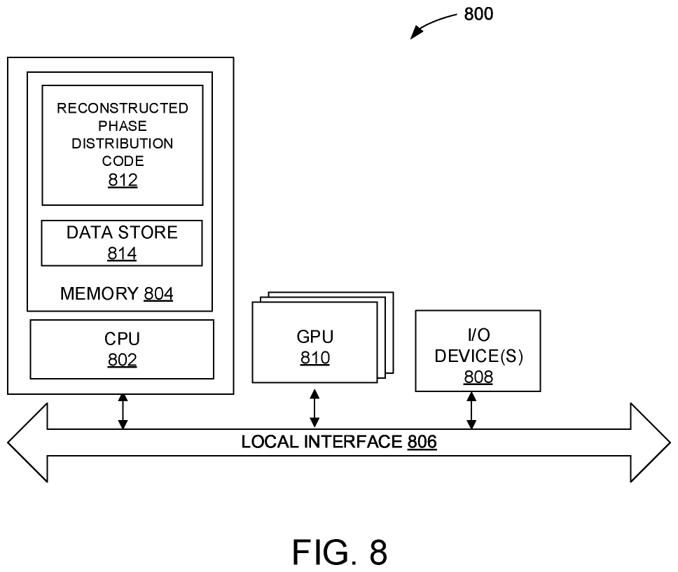

FIG. 8 depicts a schematic block diagram of a computing device 800 that can be used to implement various embodiments of the present disclosure. An exemplary computing device 800 includes at least one processor circuit, for example, having a processor 802 and a memory 804, both of which are coupled to a local interface 806, and one or more input and output (I/O) devices 808. The local interface 806 may comprise, for example, a data bus with an accompanying address/control bus or other bus structure as can be appreciated. The computing device 800 may further include Graphical Processing Unit(s) (GPU) 810 that are coupled to the local interface 806 and may utilize memory 804 and/or may have its own dedicated memory. The CPU and/or GPU(s) can perform various operations such as image enhancement, graphics rendering, image/video processing, and any of the various operations described herein.

Stored in the memory 804 are both data and several components that are executable by the processor 802. In particular, stored in the memory 804 and executable by the processor 802 may be code 812 for performing reconstructed phase distributions of a single hologram without phase retrieval or other related processes, such as code for implementing one or more artificial and/or convolutional neural network models, in accordance with embodiments of the present disclosure. Also stored in the memory 804 may be a data store 814 and other data. In addition, an operating system may be stored in the memory 804 and executable by the processor 802. The I/O devices 808 may include input devices, for example but not limited to, a keyboard, mouse, exemplary in-line digital holographic microscopy system, CMOS camera, etc. Furthermore, the I/O devices 808 may also include output devices, for example but not limited to, a printer, display, etc.

Certain embodiments of the present disclosure can be implemented in hardware, software, firmware, or a combination thereof. If implemented in software, reconstructed phase distributions of a single hologram without phase retrieval logic or functionality are implemented in software or firmware that is stored in a memory and that is executed by a suitable instruction execution system. If implemented in hardware, the reconstructed phase distributions of a single hologram without phase retrieval logic or functionality can be implemented with any or a combination of the following technologies, which are all well known in the art: discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It should be emphasized that the above-described embodiments are merely possible examples of implementations, merely set forth for a clear understanding of the principles of the present disclosure. Many variations and modifications may be made to the above-described embodiment(s) without departing substantially from the principles of the present disclosure. All such modifications and variations are intended to be included herein within the scope of this disclosure.

Therefore, at least the following is claimed:

1. A holographic imaging method comprising:
transmitting light and illuminating a semi-transparent sample object;
forming, at a hologram plane, an interference pattern of a real image of the sample object from a scattered object beam and an unscattered reference beam from the transmitted light, wherein the scattered object beam and the unscattered reference beam are in-line with one another, wherein a distance between the hologram plane to the sample object is set at a distance that substantially weakens a virtual image of the sample object formed from the scattered object beam and the unscattered reference beam;
recording the interference pattern of a hologram formed from the scattered object beam and the unscattered reference beam at a detector; and
reconstructing a 3D optical field of the hologram of the sample object to the hologram plane without phase retrieval.

2. The holographic imaging method of claim 1, further comprising:
calculating a phase distribution of the hologram from the reconstructed 3D optical field; and
calculating a thickness or volume of the sample object based on the phase distribution of the hologram.

3. The method of claim 2, wherein the sample object comprises a red blood cell mounted on a glass slide.

4. The method of claim 1, wherein a source of the light is a Helium-Neon (HeNe) laser with a wavelength of 633 nm.

5. The method of claim 1, further comprising spatially filtering and collimating the light before illuminating the sample object.

6. The method of claim 5, further comprising magnifying the hologram and transmitting the magnified hologram to the detector for recording of the hologram.

7. The method of claim 1, wherein the detector comprises a Complementary Metal Oxide Semiconductor (CMOS) camera.

8. The method of claim 1, wherein the light is coherent light.

9. The method of claim 1, wherein the distance between the sample object and the hologram plane reduces a measurement error of cell volume due to the virtual image to be less than 6%.

10. The method of claim 1, wherein the distance between the sample object and the hologram plane reduces an error of reconstructed phase due to the virtual image to be less than 10%.

11. The method of claim 1, wherein the distance between the sample object and the hologram plane is at least 50 μm.

12. The method of claim 1, further comprising implementing an autofocusing algorithm that identifies sharp features in the reconstructed optical field based on intensity variations.

13. A holographic imaging device comprising:
a light source configured to transmit light and illuminate a semi-transparent sample object;
wherein, at a hologram plane, an interference pattern of a real image of the sample object is formed from a scattered object beam and an unscattered reference beam from the transmitted light, wherein the scattered object beam and the unscattered reference beam are in-line with one another, wherein the sample object is set at a distance from the hologram plane that substantially weakens a virtual image of the sample object from a scattered object beam and an unscattered reference beam;
a detector configured to record an interference pattern of a hologram of the sample object formed from a scattered object beam and an unscattered reference beam from the transmitted light; and
a computer processor configured to:
reconstruct a 3D optical field of the hologram of the sample object to the hologram plane without phase retrieval;
calculate a phase distributions of the hologram from the reconstructed 3D optical field; and
calculate a thickness or volume of the sample object based on the phase distribution of the hologram.

14. The holographic imaging device of claim 13, wherein the distance between the sample object and the hologram plane is at least 50 μm.
